(19) United States
(12) Patent Application Publication
(10) Pub. No.: US 2025/0283232 A1
(43) Pub. Date: Sep. 11, 2025

(54) ELECTROLYSIS DEVICE

(71) Applicant: HONDA MOTOR CO., LTD., TOKYO (JP)

(72) Inventor: Naoki MITSUTA, WAKO-SHI (JP)

(21) Appl. No.: 19/058,297

(22) Filed: Feb. 20, 2025

(30) Foreign Application Priority Data
Mar. 5, 2024 (JP) 2024-032838

(51) Int. Cl. C25B 9/60; C25B 9/23

(52) U.S. Cl. CPC C25B 9/60; C25B 9/23

(57) ABSTRACT

An electrolysis cell of an electrolysis device includes a membrane electrode assembly in which an electrolyte membrane is interposed between a first electrode and a second electrode. The membrane electrode assembly is positioned between a first separator and a second separator. The electrolysis device further includes a seal member and a protection member. The protection member surrounds the outer periphery of the second electrode. The protection member includes a first portion and a second portion. The first portion is interposed between the electrolyte membrane and the seal member. The second portion is interposed between the electrolyte membrane and the second separator.

### CROSS-REFERENCE TO RELATED APPLICATIONS

This application is based upon and claims the benefit of priority from Japanese Patent Application No. 2024-032838 filed on Mar. 5, 2024, the contents of which are incorporated herein by reference.

### BACKGROUND OF THE INVENTION

### Field of the Invention

The present invention relates to an electrolysis device for performing electrolysis of a fluid.

### Description of the Related Art

As one type of electrolysis device, a water electrolysis device that electrolyzes water to obtain hydrogen and oxygen is known (for example, see JP 2019-157213 A). The water electrolysis device includes an electrolysis cell. The electrolysis cell includes a membrane electrode assembly, and a first separator and a second separator that sandwich the membrane electrode assembly therebetween. The membrane electrode assembly includes a first electrode, a second electrode, and an electrolyte membrane interposed between the first electrode and the second electrode. The first electrode is one of an anode and a cathode, and the second electrode is the other of the anode and the cathode.

When the electrolyte membrane is a proton conductor, electrons, protons, and oxygen are produced at the cathode, and hydrogen is produced at the anode. The hydrogen is at a higher pressure than the oxygen. When the electrolyte membrane is an anion conductor, hydrogen and hydroxide ions are produced at the cathode, and oxygen, water, and electrons are produced at the anode. The oxygen is at a higher pressure than the hydrogen. In this way, in the water electrolysis device, the high-pressure gas is generated at one of the first electrode and the second electrode.

### SUMMARY OF THE INVENTION

The electrolysis device is provided with a seal member which surrounds the outer periphery of the electrode where the high-pressure gas is generated and which is interposed between the separator and the electrolyte membrane. In some cases, an inner peripheral side wall portion is provided on the inner circumference of the seal member. In this configuration, a surface of the inner peripheral side wall portion that faces the electrolyte membrane may press the electrolyte membrane. Under such a situation, there is a concern that the electrolyte membrane pressed by the inner peripheral side wall portion may be deformed.

The seal member is deformed by receiving the pressure of the high-pressure gas. Accordingly, the electrolyte membrane is pressed by the deformed seal member. In this case, the electrolyte membrane pressed by the seal member may be deformed.

An object of the present invention is to solve the aforementioned problems.

An aspect of the present invention is an electrolysis device including an electrolysis cell including a membrane electrode assembly in which an electrolyte membrane is interposed between a first electrode and a second electrode, and a first separator and a second separator that sandwich the membrane electrode assembly therebetween.

The electrolysis device includes a fluid supply unit that supplies a fluid involved in an electrolytic reaction, to the first electrode, a power source that applies a voltage between the first electrode and the second electrode, a seal member that surrounds an outer periphery of the second electrode and is interposed between the electrolyte membrane and the second separator, and a protection member that surrounds an outer periphery of the second electrode. The protection member includes a first portion interposed between the electrolyte membrane and the seal member, and a second portion interposed between the electrolyte membrane and the second separator. The first portion and the second portion are different from each other.

In the protection member, the first portion interposed between the electrolyte membrane and the seal member protects the electrolyte membrane when, for example, the seal member is deformed as a result of receiving the pressure of the high-pressure gas. This prevents the electrolyte membrane from being deformed.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic perspective view of an electrolysis device (first water electrolysis device) according to a first embodiment of the present invention;

FIG. 2 is a cross-sectional view of an electrolysis cell taken along a diameter direction thereof;

FIG. 3 is a cross-sectional view of a main part of a configuration in which a protection member is provided on an electrolyte membrane such that a rubber sheet faces the electrolyte membrane and a metal sheet faces the seal member;

FIG. 4 is a cross-sectional view of a main part of a configuration in which a protection member is provided on an electrolyte membrane such that a metal sheet faces the electrolyte membrane and a rubber sheet faces the seal member;

FIG. 5 is a cross-sectional view of a main part showing a state in which the seal member is deformed;

FIG. 6 is a sectional view of a main part of an electrolysis device (second water electrolysis device) according to a second embodiment of the present invention; and

FIG. 7 is a cross-sectional view of a main part showing a state in which the seal member has moved toward an outer peripheral side wall portion.

### DETAILED DESCRIPTION OF THE INVENTION

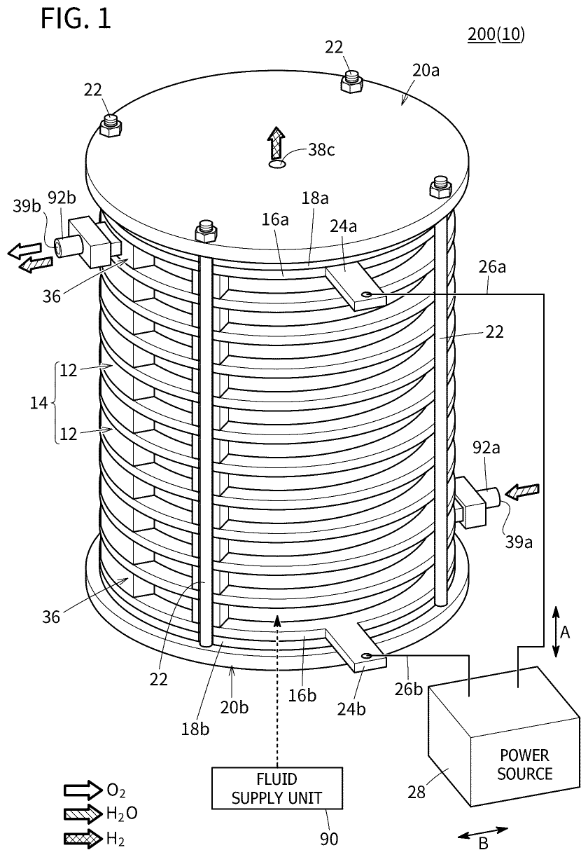

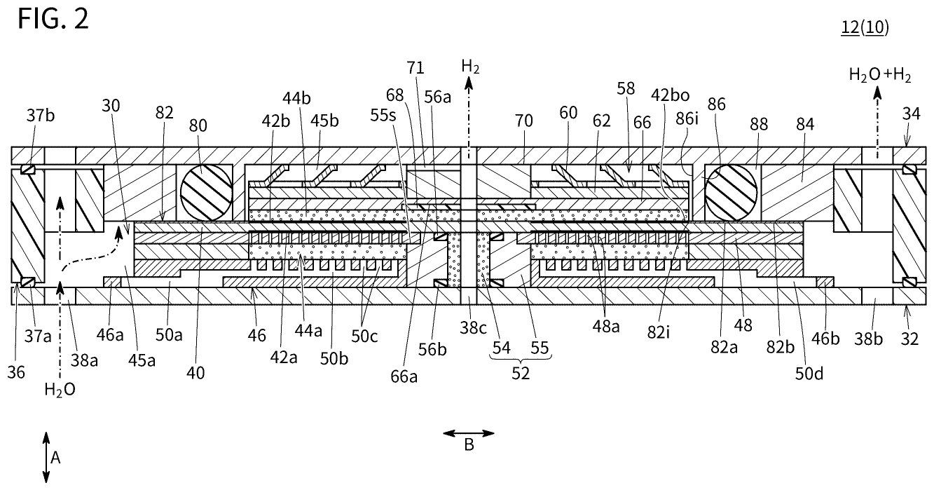

FIG. 1 is a schematic perspective view of an electrolysis device 200 according to a first embodiment. In the first embodiment, the electrolysis device 200 is a first water electrolysis device 10 that performs electrolysis of water. Therefore, the first water electrolysis device 10 will be described in detail below. However, the electrolysis device 200 is not limited to the first water electrolysis device 10, as long as it is any device that generates a gas at a second electrode 42b shown in FIG. 2.

In the first water electrolysis device 10, as a result of electrolysis of water, a first gas is generated at a first electrode 42a shown in FIG. 2, and a second gas is generated at the second electrode 42b. The second gas is set to a higher pressure than the first gas. In the present specification, the second electrode 42b refers to an electrode for obtaining a higher-pressure gas. For the sake of simplicity and easy understanding, the first embodiment will exemplify a configuration in which oxygen is generated as the first gas at the first electrode 42a and hydrogen is generated as the second gas at the second electrode 42b.

The first water electrolysis device 10 includes an electrolysis cell 12. As shown in FIG. 1, in the first water electrolysis device 10, a plurality of electrolysis cells 12 are stacked in a vertical direction (direction of arrow A), thereby forming a stack body 14. A terminal plate 16a, an insulating plate 18a, and an end plate 20a are sequentially arranged in the upward direction at one end (upper end) in the stacking direction of the stack body 14. At the other end (lower end) of the stack body 14 in the stacking direction, a terminal plate 16b, an insulating plate 18b, and an end plate 20b are arranged sequentially in the downward direction. The stacking direction of the electrolysis cells 12 may be a horizontal direction (direction of arrow B).

A pipe (not shown) is connected to the end plate 20a. The pipe is provided with a back pressure mechanism (not shown) capable of restricting the discharge of hydrogen gas from a hydrogen passage 38c described later. The end plate 20a and the end plate 20b are fastened by tightening via the tie rods 22. Accordingly, a tightening load acts on the plurality of electrolysis cells 12.

Side portions of the terminal plate 16a and the terminal plate 16b are provided respectively with a terminal portion 24a and a terminal portion 24b which protrude outward in the diametrical direction. The terminal portions 24a and 24b are electrically connected to a power source 28 for electrolysis via wirings 26a and 26b, respectively.

As shown in FIG. 2, each of the electrolysis cells 12 includes a substantially disc-shaped membrane electrode assembly 30, a first separator 32, and a second separator 34. The first separator 32 and the second separator 34 sandwich and hold the membrane electrode assembly 30 therebetween. A resin frame member 36 is disposed between the first separator 32 and the second separator 34. The resin frame member 36 surrounds the outer periphery of the membrane electrode assembly 30. The gap between the first separator 32 and the resin frame member 36 is sealed by a seal member 37a, and the gap between the resin frame member 36 and the second separator 34 is sealed by a seal member 37b.

A fluid supply passage 38a is formed at one end of the resin frame member 36 in the radial direction (the direction indicated by the arrow B) and extend in the stacking direction (direction of arrow A). A fluid supply unit 90 is connected to the fluid supply passage 38a. The fluid supply unit 90 (see FIG. 1) supplies the fluid supply passage 38a with water as a fluid.

The other end of the resin frame member 36 in the radial direction (the direction indicated by the arrow B) is provided with a fluid discharge passage 38b for discharging unreacted water, and oxygen that is generated based on electrode reaction. As shown in FIG. 1, a supply joint 92a is connected to the resin frame member 36 disposed at the other end (lowermost end) in the stacking direction. The fluid supply port 39a of the supply joint 92a communicates with the fluid supply passage 38a shown in FIG. 2. As shown in FIG. 1, a discharge joint 92b is connected to the resin frame member 36 disposed at one end (uppermost end) in the stacking direction. The fluid discharge port 39b of the discharge joint 92b communicates with the fluid discharge passage 38b shown in FIG. 2.

As shown in FIG. 2, the electrolysis cell 12 has the hydrogen passage 38c that penetrates, along the stacking direction, through a central portion, in the diametrical direction, of the electrolysis cell. Hydrogen generated by electrolysis of water flows through the hydrogen passage 38c. The pressure of the hydrogen is increased, for example, to a pressure ranging from 1 MPa to 80 MPa.

The membrane electrode assembly 30 includes an electrolyte membrane 40, the first electrode 42a, and the second electrode 42b. The electrolyte membrane 40, the first electrode 42a, and the second electrode 42b are sandwiched between a first current collector 44a and a second current collector 44b. Each of the electrolyte membrane 40, the first electrode 42a, the second electrode 42b, the first current collector 44a, and the second current collector 44b has a substantially ring shape. In the first embodiment, the first electrode 42a is an anode where an oxidation reaction occurs, and the second electrode 42b is a cathode where a reduction reaction occurs. The electrolyte membrane 40 is a proton exchange membrane through which protons can move, and is, for example, a hydrocarbon (HC)-based membrane or a fluorine-based membrane.

A space surrounded by the first separators 32, the resin frame member 36, and the electrolyte membrane 40 is a first electrode chamber 45a. The first electrode chamber 45a accommodates therein a flow path forming member 46 and the first current collector 44a. The flow path forming member 46 and the first current collector 44a are interposed between the first separator 32 and the electrolyte membrane 40. The flow path forming member 46 is interposed between the first separator 32 and the first current collector 44a in the stacking direction.

The flow path forming member 46 has an inlet protrusion 46a and an outlet protrusion 46b on the outer periphery. The inlet protrusion 46a and the outlet protrusion 46b face each other in the radial direction.

The inlet protrusion 46a is provided with a supply connection path 50a. The supply connection path 50a communicates with the fluid supply passage 38a and a fluid flow path 50b. The fluid flow path 50b communicates with a plurality of holes 50c. The holes 50c are open toward the first current collector 44a. The outlet protrusion 46b is provided with a discharge connection path 50d. The discharge connection path 50d communicates with the fluid flow path 50b and the fluid discharge passage 38b.

A protective sheet member 48 is disposed between the first current collector 44a and the first electrode 42a. The protective sheet member 48 has a plurality of through holes 48a extending along the stacking direction.

A substantially cylindrical passage body 52 is disposed at the diametrical center of the cell and interposed between the first separator 32 and the electrolyte membrane 40. The passage body 52 includes an inner cylindrical body 54 and an outer cylindrical body 55 surrounding the outer periphery of the inner cylindrical body 54. The inner cylindrical body 54 is formed of a porous body in which the hydrogen passage 38c is formed. A gap between the inner cylindrical body 54 and the outer cylindrical body 55 is sealed by an O-ring 56a and an O-ring 56b.

An annular step portion 55s is formed on an end surface of the outer peripheral portion of the outer cylindrical body 55 that faces the electrolyte membrane 40. An inner peripheral portion of the protective sheet member 48 is inserted into the annular step portion 55s.

A space surrounded by the electrolyte membrane 40, the resin frame member 36, and the second separator 34 is a second electrode chamber 45b. The second electrode chamber 45b accommodates therein the second current collector 44b and a load applying mechanism 58. The second current collector 44b and the load applying mechanism 58 are interposed between the electrolyte membrane 40 and the second separator 34.

The load applying mechanism 58 includes, for example, a conductive elastic member such as a plate spring 60. The plate spring 60 applies a load to the second current collector 44b via a metal shim member 62. The load is applied in a direction in which the second current collector 44b is pressed toward the second electrode 42b, that is, downward in the stacking direction.

A conductive sheet 66 and an insulating sheet 68 are disposed between the second current collector 44b and the shim member 62. The conductive sheet 66 is formed of, for example, a metal sheet having the hydrogen passage 38c disposed at substantially the center in the diametrical direction. The inner and outer diameters of the conductive sheet 66 are substantially equal to the inner and outer diameters of the second current collector 44b. A surface of the conductive sheet 66 that faces the second current collector 44b has a recess 66a. The insulating sheet 68 is accommodated in the recess 66a.

A cylindrical member 70 is disposed radially inward of the load applying mechanism 58. The cylindrical member 70 is interposed between the conductive sheet 66 and the second separator 34 in the stacking direction. The hydrogen passage 38c is formed at the diametrical center of the cylindrical member 70. A hydrogen discharge channel 71 is formed in one end surface of the cylindrical member 70 that faces the second separator 34. The hydrogen discharge channel 71 establishes communication between the second electrode chamber 45b and the hydrogen passage 38c.

In the stacking direction, a seal member 80 and a protection member 82 are interposed between the electrolyte membrane 40 and the second separator 34. The seal member 80 is sandwiched between the protection member 82 and the second separator 34. The protection member 82 includes a first portion 82a interposed between the electrolyte membrane 40 and the seal member 80, and a second portion 82b interposed between the electrolyte membrane 40 and the second separator 34 via an outer peripheral side wall portion 84.

The first water electrolysis device 10 has the outer peripheral side wall portion 84 and an inner peripheral side wall portion 86. The outer peripheral side wall portion 84 surrounds the seal member 80. Therefore, the inner periphery of the outer peripheral side wall portion 84 faces the outer periphery of the seal member 80. The outer peripheral side wall portion 84 is formed of, for example, a pressure-resistant member that is separate from the second separator 34 and has a ring shape. The seal member 80 surrounds the inner peripheral side wall portion 86. Therefore, the inner periphery of the seal member 80 faces the outer periphery of the inner peripheral side wall portion 86. The inner peripheral side wall portion 86 is, for example, an annular projection projecting downward from the lower surface of the second separator 34. In this case, the inner peripheral side wall portion 86 is a portion of the second separator 34.

The outer peripheral side wall portion 84 may be an annular projection projecting downward from the lower surface of the second separator 34. The inner peripheral side wall portion 86 may be formed of a ring-shaped member that is separate from the second separator 34.

The outer peripheral side wall portion 84 and the inner peripheral side wall portion 86 may be provided on the same member. In this case, the member has, for example, a ring-shaped portion that is separate from the second separator 34. The outer peripheral side wall portion 84 is provided so as to protrude downward from the lower surface of the outer peripheral end of the ring-shaped portion. The inner peripheral side wall portion 86 is provided to protrude downward from the lower surface of the inner peripheral end of the ring-shaped portion.

In any of the configurations, an annular groove 88 is formed between the outer peripheral side wall portion 84 and the inner peripheral side wall portion 86. The seal member 80 is inserted into the annular groove 88. As shown in FIG. 2, in the protection member 82, an inner peripheral end 82i of the first portion 82a is located inward of an inner peripheral end 86i of the inner peripheral side wall portion 86. The second electrode chamber 45b surrounded by the inner peripheral side wall portion 86 and the second separator 34 is formed inward of the inner peripheral side wall portion 86. The second electrode chamber 45b accommodate therein the second electrode 42b, the second current collector 44b, the conductive sheet 66, the insulating sheet 68, the shim member 62, and the load applying mechanism 58.

The protection member 82 is, for example, a single annular sheet. In the protection member 82 having an annular shape, the inner peripheral surface of the first portion 82a is close to the outer peripheral portion 42bo of the second electrode 42b. The inner peripheral surface of the first portion 82a may abut on the outer peripheral portion 42bo of the second electrode 42b. The protection member 82 may has a configuration of not being interposed between the electrolyte membrane 40 and the second electrode 42b.

Suitable examples of the sheet include a metal sheet or a rubber sheet. However, the protection member 82 is not limited to a metal sheet or a rubber sheet. The protection member 82 may be formed of carbon paper.

When the first water electrolysis device 10 is manufactured, the end plates 20a and 20b are fastened together by tightening via the tie rods 22 as described above. Accordingly, a tightening load acts on the plurality of electrolysis cells 12. When the protection member 82 is formed of a metal sheet, the tightening load is moderated. Therefore, the tightening load can be made uniform in the plurality of electrolysis cells 12.

When the protection member 82 is formed of a rubber sheet, the tightening load can be made uniform in the plurality of electrolysis cells 12 in the same manner as described above. The rubber sheet is easily compressed when the first water electrolysis device 10 is tightened. Therefore, in each of the plurality of electrolysis cells 12, the pressure distribution in the plane direction can be equalized. As a result, the cell voltage in each of the plurality of electrolysis cells 12 is stabilized at a low value. Furthermore, the difference in voltage between the plurality of electrolysis cells 12 is reduced.

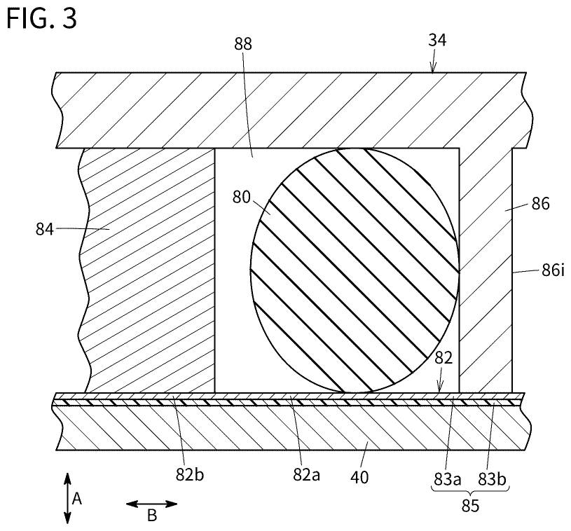

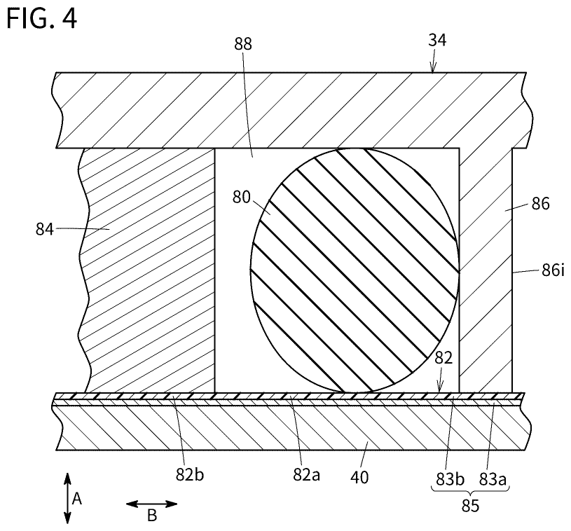

As shown in FIGS. 3 and 4, the protection member 82 may be a laminated sheet 85. A suitable example of the laminated sheet 85 is a laminate body of a metal sheet 83a and a rubber sheet 83b. In this case, in the configuration shown in FIG. 3, the rubber sheet 83b faces the electrolyte membrane 40, and the metal sheet 83a faces the seal member 80. In the configuration shown in FIG. 4, the metal sheet 83a faces the electrolyte membrane 40, and the rubber sheet 83b faces the seal member 80.

In the configuration in which the rubber sheet 83b faces the electrolyte membrane 40 and the metal sheet 83a faces the seal member 80 (see FIG. 3), even if the metal sheet 83a has minute irregularities, the rubber sheet 83b is deformed to fill the irregularities, so that the protection member 82 is in close contact with the electrolyte membrane 40. Therefore, the bonding strength of the protection member 82 to the electrolyte membrane 40 is high.

In the configuration in which the metal sheet 83a faces the electrolyte membrane 40 and the rubber sheet 83b faces the seal member 80 (see FIG. 4), the protection member 82 is also in close contact with the electrolyte membrane 40 in the same manner as described above. In addition, the electrolyte membrane 40 and the second separator 34 are effectively insulated from each other. Further, since the rubber sheet 83b is in abutment with the second separator 34, the second separator 34 is protected from corrosion when the second separator 34 is made of metal.

In the first embodiment, the inner peripheral end 82i of the protection member 82 (first portion 82a) is located inward of the inner peripheral end 86i of the inner peripheral side wall portion 86. Thus, as a result of the above-described tightening, a pressing force is applied to the protection member 82 from the lower surface of the inner peripheral side wall portion 86 facing the electrolyte membrane 40. At this time, the protection member 82 absorbs the pressing force. Therefore, the pressing force acting on the electrolyte membrane 40 is reduced, and thus the deformation of the electrolyte membrane 40 is suppressed.

Next, the operation of the first water electrolysis device 10 will be described.

A voltage is applied from the power source 28 to the terminal portion 24a of the terminal plate 16a and the terminal portion 24b of the terminal plate 16b shown in FIG. 1. Water as a fluid is supplied from the fluid supply unit 90. The water flows into the fluid supply passage 38a (see FIG. 2) of the electrolysis cell 12 through the fluid supply port 39a. The water flows through the fluid supply passage 38a and the supply connection path 50a in the electrolysis cell 12, and then flows into the fluid flow path 50b of the flow path forming member 46. Then, the water is supplied from the plurality of holes 50c to the first current collector 44a.

The water is electrolyzed at the first electrode 42a. As a result, protons, electrons, and oxygen are generated. That is, the water is involved in the electrode reaction (oxidation reaction) at the first electrode 42a. The protons move to the second electrode 42b through the electrolyte membrane 40, and are combined with the electrons in the second electrode 42b. As a result, hydrogen is produced. The hydrogen is discharged from the second electrode chamber 45b to the hydrogen passage 38c through the pores of the second current collector 44b and the hydrogen discharge channel 71.

The back pressure mechanism restricts the discharge of the hydrogen from the hydrogen passage 38c. Therefore, when the electrolysis reaction of water proceeds in the electrolysis cell 12, the internal pressure of the second electrode chamber 45b increases due to the produced hydrogen. As a result, the internal pressure of the second electrode chamber 45b becomes higher than the internal pressure of the first electrode chamber 45a, and the hydrogen in the hydrogen passage 38c is maintained at a high pressure. Thus, the high-pressure hydrogen whose pressure has been increased to a predetermined pressure can be taken out from the first water electrolysis device 10. On the other hand, oxygen produced by the electrode reaction (reduction reaction) at the first electrode 42a is entrained in the unreacted water and discharged to the outside of the first water electrolysis device 10 through the fluid discharge passage 38b and the fluid discharge port 39b at normal pressure.

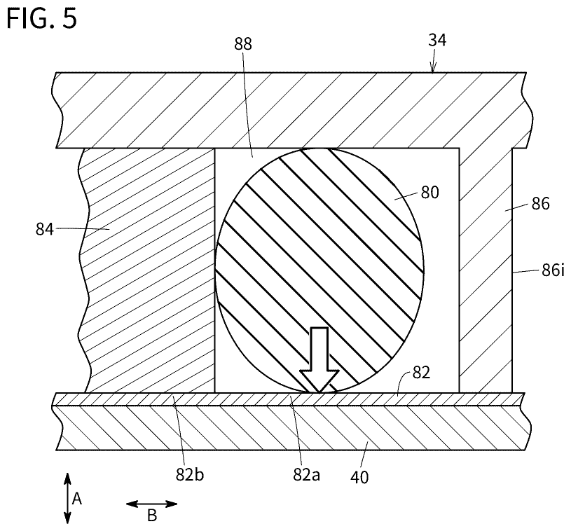

The high-pressure hydrogen in the second electrode chamber 45b flows into the annular groove 88. Therefore, as shown in FIG. 5, the seal member 80 may be pressed by the high-pressure hydrogen and may be pressed against the inner peripheral surface of the outer peripheral side wall portion 84. Further, the seal member 80 is pressed by the high-pressure hydrogen and is deformed so as to expand along the stacking direction.

As the seal member 80 is deformed as described above, the lower portion of the seal member 80 facing the protection member 82 and the electrolyte membrane 40 presses the protection member 82 such that the protection member 82 extends in the direction orthogonal to the stacking direction. Therefore, the pressing force from the seal member 80 is relaxed by the protection member 82. Thus, the protection member 82 extends from the second electrode chamber 45b where the high-pressure hydrogen is generated to the annular groove 88 into which the high-pressure hydrogen flows. As a result, deformation of the electrolyte membrane 40 is suppressed.

Since the deformation of the electrolyte membrane 40 is suppressed, the increase in the amount of permeation to the first electrode 42a of the high-pressure hydrogen generated in the second electrode 42b is suppressed. Therefore, the amount of hydrogen that is collected through the hydrogen passage 38c is prevented from being reduced. In addition, hydrogen does not interfere with the electrode reaction at the first electrode 42a, thus a decrease in reaction efficiency is avoided. For the reasons described above, sufficient amounts of hydrogen and oxygen can be obtained by the electrolysis of water.

The effects of the first embodiment are summarized as follows.

As shown in FIG. 2, the first water electrolysis device 10 according to the first embodiment includes the protection member 82 interposed between the electrolyte membrane 40 and the seal member 80. The first portion 82a of the protection member 82 suppresses deformation of the electrolyte membrane 40 when the seal member 80 is deformed due to generation of hydrogen at the second electrode 42b.

As a result, the progress of the electrode reaction in the first electrode 42a or the second electrode 42b is prevented from being reduced due to the deformation of the electrolyte membrane 40. Further, it is possible to suppress a decrease in the collected amount of the generated high-pressure hydrogen. Thus, sufficient amounts of hydrogen and oxygen can be obtained by the electrolysis of water.

The inner peripheral surface of the protection member 82 abuts on the outer peripheral portion 42bo of the second electrode 42b.

The end surface of the electrolyte membrane 40 facing the seal member 80 is mostly covered with the protection member 82. Therefore, the deformation of the electrolyte membrane 40 is further suppressed.

In a configuration, the protection member 82 is made of a metal sheet.

In this case, the tightening load applied when the first water electrolysis device 10 is tightened is relaxed by the protection member 82. Therefore, the tightening load can be made uniform in the plurality of electrolysis cells 12.

In another configuration, the protection member 82 is made of a rubber sheet.

In this configuration also, the tightening load can be made uniform in the plurality of electrolysis cells 12 as in the above case. In addition, the protection member 82 made of a rubber sheet is easily compressed when the first water electrolysis device 10 is tightened. Therefore, in each of the plurality of electrolysis cells 12, the pressure distribution in the plane direction can be equalized. As a result, in each of the plurality of electrolysis cells 12, the cell voltage is stabilized at a low value. Furthermore, the difference in voltage between the plurality of electrolysis cells 12 is reduced.

In another configuration, the protection member 82 has a laminated sheet 85 of a metal sheet 83a and a rubber sheet 83b.

In this configuration, as shown in FIG. 3, when the rubber sheet 83b faces the electrolyte membrane 40 and the metal sheet 83a faces the seal member 80, the electrolyte membrane 40 and the second separator 34 are insulated from each other. Further, since the rubber sheet 83b is interposed between the metal sheet 83a and the electrolyte membrane 40, metal of the metal sheet 83a is prevented from mixing into the electrolyte membrane 40.

On the contrary, as shown in FIG. 4, when the metal sheet 83a faces the electrolyte membrane 40 and the rubber sheet 83b faces the seal member 80, the electrolyte membrane 40 and the second separator 34 are insulated from each other in the same manner as described above. Further, since the rubber sheet 83b is in abutment with the second separator 34, the second separator 34 is protected from corrosion when the second separator 34 is made of metal.

The above effects are also obtained in a second embodiment described later. In addition, the first embodiment has the following unique effects.

The first water electrolysis device 10 includes an outer peripheral side wall portion 84 facing the outer periphery of the seal member 80, and an inner peripheral side wall portion 86 facing the inner periphery of the seal member 80 and having the outer periphery surrounded by the seal member 80. The annular groove 88 is formed between the outer peripheral side wall portion 84 and the inner peripheral side wall portion 86. The seal member 80 is inserted into the annular groove 88. The inner peripheral end 82i of the protection member 82 is located inward of the inner peripheral end 86i of the inner peripheral side wall portion 86.

When the stack body 14 is tightened, the pressing force acting in the direction from the lower surface of the inner peripheral side wall portion 86 toward the electrolyte membrane 40 is absorbed by the protection member 82. Therefore, in this case as well, deformation of the electrolyte membrane 40 is suppressed.

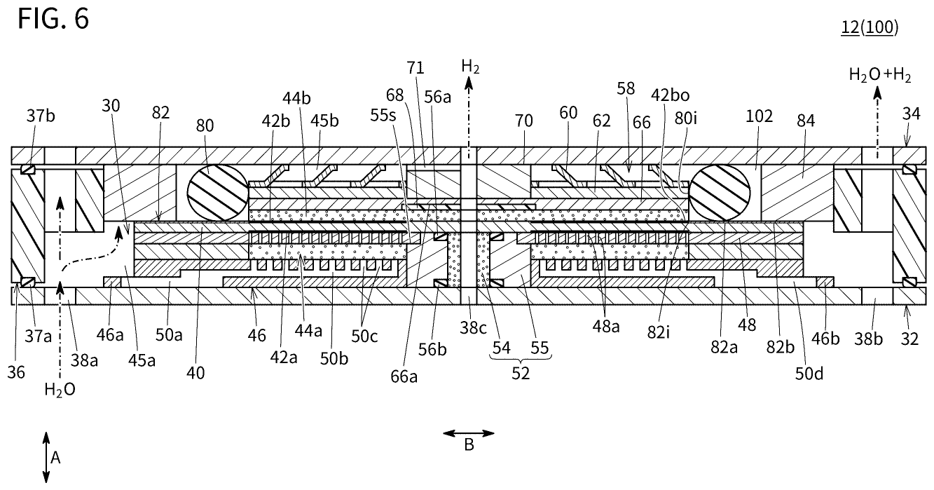

Next, a second water electrolysis device 100 according to a second embodiment will be described with reference to FIG. 6. The second water electrolysis device 100 is a device that performs electrolysis of water, similarly to the first water electrolysis device 10. Moreover, it should be noted that the same constituent elements as those shown in FIGS. 1 to 5 are designated by the same reference numerals and detailed description of such elements will be omitted.

The second water electrolysis device 100 does not include the inner peripheral side wall portion 86. Therefore, the seal member 80 surrounds the outer peripheral surface of the second electrode 42b. A space 102 communicating with the second electrode chamber 45b is formed between the outer peripheral surface of the second electrode 42b and the inner peripheral surface of the outer peripheral side wall portion 84. In the space 102, the seal member 80 is movable along the diameter direction.

In the second embodiment, the inner peripheral end 82i of the protection member 82 is located inward of an inner peripheral end 80i of the seal member 80. That is, the inner peripheral end 82i of the protection member 82 extends into the space 102. Therefore, the upper surface of the protection member 82 is one surface that forms the space 102. The inner peripheral surface of the annular protection member 82 abuts on the outer peripheral portion of the second electrode 42b.

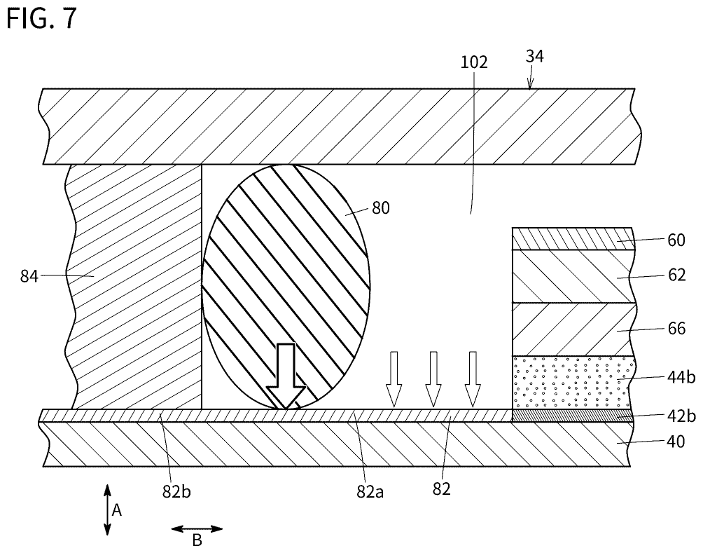

In the second embodiment, when high-pressure hydrogen is generated in the second electrode 42b, the high-pressure hydrogen is temporarily stored in the space 102. The high-pressure hydrogen in the space 102 pushes the seal member 80 toward the outer peripheral side wall portion 84. As a result, as shown in FIG. 7, the seal member 80 is moved toward the inner peripheral surface of the outer peripheral side wall portion 84 and compressed. At this time also, as in the first embodiment, the pressing force from the lower portion of the seal member 80 is absorbed (relaxed) by the protection member 82.

In addition, the exposed area of the upper surface of the protection member 82 increases in accordance with the above-described deformation of the seal member 80. Therefore, the pressure of the high-pressure hydrogen mainly acts on the upper surface of the protection member 82. Therefore, the protection member 82 is prevented from peeling off from the electrolyte membrane 40. Therefore, the electrolyte membrane 40 is effectively protected by the protection member 82. Even in the above-described configuration where the inner peripheral side wall portion 86 is not provided, the protection member 82 can prevent the electrolyte membrane 40 from being deformed. Therefore, in the second embodiment also, hydrogen and oxygen can be obtained in sufficient amounts by electrolysis of water.

The second embodiment exhibits the following advantageous effects.

The second water electrolysis device 100 includes the outer peripheral side wall portion 84 facing the outer periphery of the seal member 80. The space 102 is formed between the outer peripheral surface of the second electrode 42b and the inner peripheral surface of the outer peripheral side wall portion 84. The seal member 80 is movably accommodated in the space 102. The inner peripheral end 82i of the protection member 82 is located inward of the inner peripheral end 80i of the seal member 80.

When the seal member 80 is moved toward the outer peripheral side wall portion 84 by the high-pressure hydrogen stored in the space 102, the exposed area of the upper surface of the protection member 82 increases. Therefore, the pressure of the high-pressure hydrogen mainly acts on the upper surface of the protection member 82. Therefore, the protection member 82 is prevented from peeling off from the electrolyte membrane 40.

In the first embodiment and the second embodiment, oxygen is generated as the first gas at the first electrode 42a, and hydrogen is generated as the second gas at the second electrode 42b. However, there can be another configuration in which hydrogen is generated as the first gas at the first electrode 42a, and oxygen is generated as the second gas at the second electrode 42b. The latter configuration will be briefly described.

When the electrolyte membrane 40 is made of an anion conductor, a reduction reaction for producing hydrogen and hydroxide ions from water occurs at the first electrode 42a. The hydroxide ions are conducted through the electrolyte membrane 40 and move to the second electrode 42b. In the second electrode 42b, an oxidation reaction occurs in which oxygen, water, and electrons are produced from hydroxide ions. The pressure of the oxygen is increased to a predetermined pressure by the back pressure mechanism. In this way, the first and second water electrolysis devices 10 and 100 can produce hydrogen as the first gas at the first electrode 42a and can produce oxygen at a high pressure as the second gas at the second electrode 42b.

As described above, the electrolysis device 200 according to the present invention is not limited to the first water electrolysis device 10 and the second water electrolysis device 100 that perform electrolysis of water. That is, the present invention can be applied to the electrolysis device 200 that performs electrolysis of a substance (fluid) other than water.

The following Supplementary Notes are further disclosed in relation to the above embodiments.

### Supplementary Note 1

The electrolysis device (200) of the present disclosure includes the electrolysis cell (12) including the membrane electrode assembly (30) in which the electrolyte membrane (40) is interposed between the first electrode (42a) and the second electrode (42b), and the first separator (32) and the second separator (34) that sandwich the membrane electrode assembly therebetween. The electrolysis device further includes the fluid supply unit (90) that supplies a fluid involved in the electrolytic reaction, to the first electrode, the power source (28) that applies a voltage between the first electrode and the second electrode, the seal member (80) that surrounds the outer periphery of the second electrode and is interposed between the electrolyte membrane and the second separator, and the protection member (82) that surrounds the outer periphery of the second electrode. The protection member surrounds the outer periphery of the second electrode, and includes the first portion (82a) interposed between the electrolyte membrane and the seal member, and the second portion (82b) interposed between the electrolyte membrane and the second separator. The first portion and the second portion are different from each other.

When the seal member is deformed as a result of receiving the pressure of the high-pressure gas, the protection member 82 absorbs (relaxes) the pressing force acting in the direction from the deformed seal member toward the electrolyte membrane. This suppresses deformation of the electrolyte membrane. Therefore, the progress of the electrode reaction in the second electrode is prevented from being reduced due to the deformation of the electrolyte membrane. Therefore, a sufficient amount of gas can be obtained at the second electrode by the electrolysis.

### Supplementary Note 2

The electrolysis device according to Supplementary Note 1 may further include the outer peripheral side wall portion (84) facing the outer periphery of the seal member; the inner peripheral side wall portion (86) facing the inner periphery of the seal member and including the outer periphery surrounded by the seal member; and the annular groove (88) formed between the outer peripheral side wall portion and the inner peripheral side wall portion, and the seal member may be inserted into the annular groove, and the inner peripheral end (82i) of the protection member may be located inward of the inner peripheral end (86i) of the inner peripheral side wall portion.

When the electrolysis device is tightened, the pressing force acting in the direction from the inner peripheral side wall portion toward the electrolyte membrane is absorbed (relaxed) by the protection member. That is, in this case as well, deformation of the electrolyte membrane is avoided by the protection member.

### Supplementary Note 3

The electrolysis device according to Supplementary Note 1 may further include the outer peripheral side wall portion (84) facing the outer periphery of the seal member; and the space (102) formed between the outer peripheral surface of the second electrode and the inner peripheral surface of the outer peripheral side wall portion and configured to movably accommodate the seal member, and the inner peripheral end (82i) of the protection member may be located inward of the inner peripheral end (80i) of the seal member.

When the high-pressure gas is generated at the second electrode, the high-pressure gas in the space pushes the seal member toward the outer peripheral side wall portion. Accordingly, the seal member moves toward the inner peripheral surface of the outer peripheral side wall portion, and thus the exposed area of the upper surface (surface facing the space) of the protection member increases.

Therefore, the pressure of the high-pressure gas mainly acts on the upper surface of the protection member. Therefore, the protection member is prevented from being peeled off from the electrolyte membrane. Therefore, the electrolyte membrane is protected by the protection member.

### Supplementary Note 4

In the electrolysis device according to any one of Supplementary notes 1 to 3, the inner peripheral surface of the protection member may abut on the outer peripheral portion (42bo) of the second electrode.

In the electrolyte membrane, most of the end surface facing the seal member is covered with the protection member. Therefore, the deformation of the electrolyte membrane is further suppressed.

### Supplementary Note 5

In the electrolysis device according to any one of Supplementary notes 1 to 4, the protection member may be made of a metal sheet.

According to this configuration, the tightening load applied to the plurality of electrolysis cells can be made uniform.

### Supplementary Note 6

In the electrolysis device according to any one of Supplementary notes 1 to 4, the protection member may be made of a rubber sheet.

In this configuration also, the tightening load can be made uniform in the plurality of electrolysis cells as in the above. In addition, the protection member made of a rubber sheet is easily compressed when the electrolysis device is tightened. Therefore, in each of the plurality of electrolysis cells, the pressure distribution in the plane direction can be equalized. As a result, in each of the plurality of electrolysis cells, the cell voltage is stabilized at a low value. Furthermore, the difference in voltage between the plurality of electrolysis cells is reduced.

### Supplementary Note 7

In the electrolysis device according to any one of Supplementary Notes 1 to 4, the protection member may include the laminated sheet (85) of the metal sheet (83a) and the rubber sheet (83b).

In the configuration in which the rubber sheet faces the electrolyte membrane and the metal sheet faces the seal member, the electrolyte membrane and the second separator can be insulated from each other. Further, metal is prevented from being mixed into the electrolyte membrane from the metal sheet.

Similarly, also in the configuration in which the metal sheet faces the electrolyte membrane and the rubber sheet faces the seal member, the electrolyte membrane and the second separator can be insulated from each other. Further, when the second separator is made of metal, the second separator can be protected from corrosion by the rubber sheet.

### Supplementary Note 8

The electrolysis device according to any one of Supplementary notes 1 to 7 may be the water electrolysis device (10, 100) configured to perform electrolysis of water supplied as the fluid, and a gas generated at the second electrode may have a higher pressure than a gas generated at the first electrode.

In this case, hydrogen and oxygen can be obtained. As described above, when the electrolyte membrane is a proton conductor (H⁺ conductor), the gas generated at the first electrode is oxygen, and the gas generated at the second electrode (high-pressure gas) is hydrogen. In contrast, when the electrolyte membrane is an anion conductor (OH⁻ conductor), the gas generated at the first electrode is hydrogen, and the gas generated at the second electrode (high-pressure gas) is oxygen.

Moreover, it should be noted that the present invention is not limited to the disclosure described above, but various configurations may be adopted therein without departing from the essence and gist of the present invention.

1. An electrolysis device comprising:
an electrolysis cell including a membrane electrode assembly in which an electrolyte membrane is interposed between a first electrode and a second electrode, and a first separator and a second separator that sandwich the membrane electrode assembly therebetween;
a fluid supply unit configured to supply a fluid involved in an electrolytic reaction, to the first electrode;
a power source configured to apply a voltage between the first electrode and the second electrode;
a seal member surrounding an outer periphery of the second electrode and interposed between the electrolyte membrane and the second separator; and
a protection member that surrounds an outer periphery of the second electrode, the protection member including a first portion interposed between the electrolyte membrane and the seal member, and a second portion different from the first portion and interposed between the electrolyte membrane and the second separator.

2. The electrolysis device according to claim 1, further comprising:
an outer peripheral side wall portion facing an outer periphery of the seal member;
an inner peripheral side wall portion facing an inner periphery of the seal member and including an outer periphery surrounded by the seal member; and
an annular groove formed between the outer peripheral side wall portion and the inner peripheral side wall portion,
wherein the seal member is inserted into the annular groove, and
an inner peripheral end of the protection member is located inward of an inner peripheral end of the inner peripheral side wall portion.

3. The electrolysis device according to claim 1, further comprising:
an outer peripheral side wall portion facing an outer periphery of the seal member; and
a space formed between an outer peripheral surface of the second electrode and an inner peripheral surface of the outer peripheral side wall portion and configured to movably accommodate the seal member,
wherein an inner peripheral end of the protection member is located inward of an inner peripheral end of the seal member.

4. The electrolysis device according to claim 1, wherein an inner peripheral surface of the protection member abuts on an outer peripheral portion of the second electrode.

5. The electrolysis device according to claim 1, wherein the protection member is made of a metal sheet.

6. The electrolysis device according to claim 1, wherein the protection member is made of a rubber sheet.

7. The electrolysis device according to claim 1, wherein the protection member includes a laminated sheet of a metal sheet and a rubber sheet.

8. The electrolysis device according to claim 7, wherein the metal sheet and the rubber sheet are laminated in a manner so that the rubber sheet faces the electrolyte membrane and the metal sheet faces the seal member.

9. The electrolysis device according to claim 7, wherein the metal sheet and the rubber sheet are laminated in a manner so that the metal sheet faces the electrolyte membrane and the rubber sheet faces the seal member.

10. The electrolysis device according to claim 1, wherein the electrolysis device is a water electrolysis device configured to perform electrolysis of water supplied as the fluid, and a gas generated at the second electrode has a higher pressure than a gas generated at the first electrode.
